(19) United States
(12) Patent Application Publication
(10) Pub. No.: US 2024/0135305 A1
(43) Pub. Date: Apr. 25, 2024

(54) ADAPTIVE LOGISTICS NAVIGATION ASSISTANCE BASED ON PACKAGE FRAGILITY

(71) Applicant: Dell Products L.P., Round Rock, TX (US)

(72) Inventors: Eric L. Caron, Ottawa (CA); Eric Bruno, Shirley, NY (US); Jason Bonafide, Winter Garden, FL (US); Nalinkumar Mistry, Ottawa (CA); Vinicius Michel Gottin, Rio de Janeiro (BR)

(21) Appl. No.: 18/049,502

(22) Filed: Oct. 24, 2022

(51) Int. Cl. G06Q 10/08; G05D 1/00

(52) U.S. Cl. CPC G06Q 10/0832; G05D 1/0088; G05D 1/0094; G06Q 10/0833; G05D 2201/0216

(57) ABSTRACT

One example method includes receiving datasets based on one or more instances of sensor data that are received from one or more sensors. The sensor data is associated with an aggregate fragility level that indicates how fragile one or more packages being transported by a movable edge node in an edge environment are. Features that are based on the datasets are extracted. Based on the extracted features, events that indicate anomalous driving patterns for the movable edge node are determined. In response to determining the events, an alarm based on a predetermined threshold that is based on the aggregate fragility level is generated.

### FIELD OF THE INVENTION

Embodiments of the present invention generally relate to logistics and event detection. More particularly, at least some embodiments of the invention relate to systems, hardware, software, computer-readable media, and methods for monitoring objects in an environment to facilitate logistics operations and for supporting decision making tasks in environments that include multiple objects based on package fragility.

### BACKGROUND

Logistics in environments such as a warehouse can be difficult to monitor and manage at least because many different objects in the environment may exist and/or operate simultaneously. Many of the objects in the warehouse, for example, are mobile in nature while other objects are stationary or fixed. As a result, care should be exercised to ensure that accidents or other problems do not occur. This can be difficult as many of the objects operate concurrently, and their relative positions may not be known to each other.

Many environments may include mobile devices or machines, which are examples of objects. For example, mobile devices such as forklifts or Autonomous Mobile Robots (AMR) may operate in a warehouse environment. Forklift operators or AMRs need to look out for each other in addition to taking care around other objects or hazards such as shelving or storage space, pillars, docks, pallets, and the like. Even if these forklift operators or AMRs are able to communicate with each other, it is difficult to coordinate the movement of multiple forklifts and ensure that undesirable interactions do not occur.

The movement of forklifts or AMRs in an environment can lead to dangerous situations because their movement can vary significantly. In addition to paying attention to other forklifts or AMRs, forklifts or AMRs may experience dangerous events without interacting with other objects. Further, forklift operators are not usually aware of what types of packages they may be transporting as it is difficult to determine fragility levels from their operating location. Packages having a fragility level may require more care than a package that is not as fragile.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1A discloses aspects of an environment in which embodiments of the invention may be deployed or implemented;

FIG. 1B illustrates an embodiment of determining the geometry information;

FIG. 2 discloses aspects of an environment in which embodiments of the invention may be deployed or implemented;

FIGS. 3A and 3B illustrate aspects of training a machine-learning driving model;

FIGS. 4 and 4B illustrate an example architecture of an adaptive driving module; and

FIG. 5 discloses aspects of a computing device, system, or entity.

### DETAILED DESCRIPTION OF SOME EXAMPLE EMBODIMENTS

Embodiments of the present invention generally relate to logistics and event detection. More particularly, at least some embodiments of the invention relate to systems, hardware, software, computer-readable media, and methods for supporting decision making tasks in complex environments.

Embodiments of the invention can be applied or implemented to provide or perform logistics operations in different types of environments. Generally, an environment may include objects, including mobile objects, movable objects, and/or stationary or static objects. These objects may include or be associated with sensors of varying types that generate data. The data may be analyzed to detect events and/or to perform actions upon detecting an event.

The data generated by the sensors can be used to perform logistics operations, which include by way of example and not limitation, event detection operations, cornering detection operations, tracking operations, trajectory prediction operations, trajectory operations, alerting operations, positioning operations, object management operations, object monitoring operations, automation operations, safety operations, hazard detection operations, hazard avoidance operations, auditing operations, management operations, or the like or combination thereof. More specifically, embodiments of the invention perform logistics, including decision making operations, based on sensor data generated at edge nodes in an edge environment.

Embodiments of the invention may further relate to detecting events in the trajectories of mobile objects operating in far edge environments that are indicative of anomalous driving patterns. Mobile objects may include, but are not limited to, autonomous mobile robots or vehicles, automatic guided vehicles, mobile machines capable of being driven/pulled/pushed/moved, and the like. Embodiments may relate to mobile devices or vehicles operating in, by way of example, manufacturing, retail, and other environments.

Embodiments of the invention are particularly discussed with respect to the operation of forklifts in a warehouse environment. Embodiments of the invention can be applied to other mobile devices, vehicles, or machines in other environments.

For example, embodiments of the invention are disclosed with respect to detecting unsafe or dangerous events. However, embodiments of the invention can be adapted to detect other types of specific events and/or to generating alerts and notifications. Embodiments may also perform automated operations such as generating notifications or alerts when an event is detected, cutting power to a device, or the like. Embodiments of the invention are further discussed in the context of an environment such as a warehouse.

From the perspective of a mobile device such as a forklift, for example, all other objects may constitute hazards. Hazards, as used herein, does not necessarily refer to dangerous objects. Thus, from the perspective of a specific forklift, hazards include other objects such as other forklifts, people, pallets, zones (e.g., defined areas), docks, corridors, corners, or the like or any combination thereof. Further, the definition of a hazard or object may also be dependent on the environment (or domain).

Embodiments of the invention are achieved, in part, by equipping the objects in the environment with hardware such as sensors, processors, memory, networking hardware, or the like. In some examples, the objects may already be equipped with this type of hardware or portions thereof. The hardware may depend on the nature of the associated object. Mobile objects, for example, may be equipped with a different set of sensors compared to sensors or devices associated with a stationary or movable object. For example, hardware such as sensors, processors, memory, or the like may be integrated with a forklift. A pallet, in contrast, may only have an RFID (Radio Frequency Identification) tag.

The hardware (and/or any software thereon) may be referred to as a node. However, reference to a node may also constitute a reference to the object associated with the node and on which the node is attached. Reference to an object, such as a forklift, may refer to the object and/or the node.

Nodes in the environment may be referred to as edge or far edge nodes as they operate on the edge of a network and may communicate with a central node operating at a near-edge infrastructure and/or in a datacenter. The central node is typically more computationally powerful than the edge nodes.

In one example, a node may be associated with sensors including position sensors and/or inertial sensors. The position and/or inertial sensors may generate data that allows movement to be detected, measured, or inferred. A machine learning model may be trained to detect that are indicative of anomalous driving patterns for the movable edge node and take corrective actions such as generating alerts, notifying operations, or the like.

In some embodiments, the edge nodes may each have sufficient hardware (e.g., processor, memory, networking hardware) to process data generated by the node's sensors and/or data about other nodes that is broadcast by a central node or by the other local nodes or other objects in the environment. The central node is able to perform more complex and thorough processing of the data generated at or by nodes in the edge environment.

As previously stated, each node in the environment may be associated with one or more sensors. A forklift, for example, may be associated with a node that includes or is associated with sensors positioned at various locations on the forklift. The sensors may be placed on the metal structures that move the forks or arm (e.g., at the distal ends) and/or on the body of the forklift. This allows the position of the forklift (and of the arms) to be determined. Other information such as height, width, and length of the forklift may also be known or determined and taken into account. However, the position data may be combined to form a single position and/or orientation of the forklift. For example, if the position is displayed on a monitor, the position of each forklift may be a short line to represent position and an arrow to represent orientation or direction. The interface may be augmented with other data such as speed, whether the forklift is turning, whether the forks are moving up/down, or the like.

The node associated with a forklift may include other sensors such as cameras, temperature sensors, velocity sensors, motion sensors, acceleration/deceleration sensors, or the like or combination thereof may also be provided. In general, the sensors associated with a forklift may generate data that can be used to detect objects, detect events or conditions, record events, determine a position/orientation/direction/trajectory of the forklift in the warehouse (or its vicinity), velocity, direction of travel, or the like. The sensor data may be processed at the node and/or at the central node to detect/identify objects and events, determine a position of the forklift and/or predict a trajectory of the forklift and/or perform localized decision-making operations.

Movable objects such as pallets or products may be associated with a node that includes RFID tags such that the positions of objects such as pallets can be read and tracked in the environment. Personal cellular phones may be used to track the positions/movement of people in the environment. The locations of other objects such as docks, corridors, or the like does not change and is known or programmed into the edge nodes and/or the central node that are performing logistics operations.

The warehouse is an example of an edge environment in which quickness and accuracy in decision making (including safety related decisions) is useful. Embodiments of the invention may detect objects, enable real-time object aware event detection, detect events that are indicative of anomalous driving patterns for the movable edge node, or the like. Data originating at the nodes is collected from the nodes and processed using computing resources of the node. Each node, for example, may have a local model configured to generate inferences from locally generated sensor data. Data from all nodes may be received by a central node (e.g., container(s), physical machine(s), server(s), virtual machine(s)) operating at a near-edge infrastructure (or the cloud) and processed using resources of the near-edge infrastructure (or cloud).

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

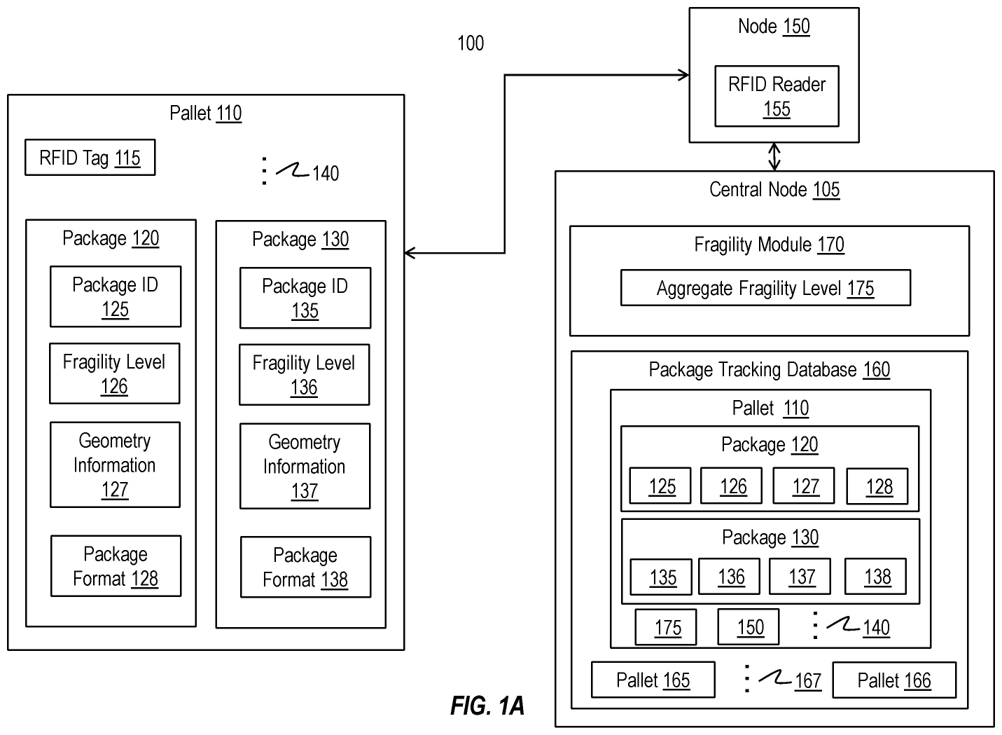

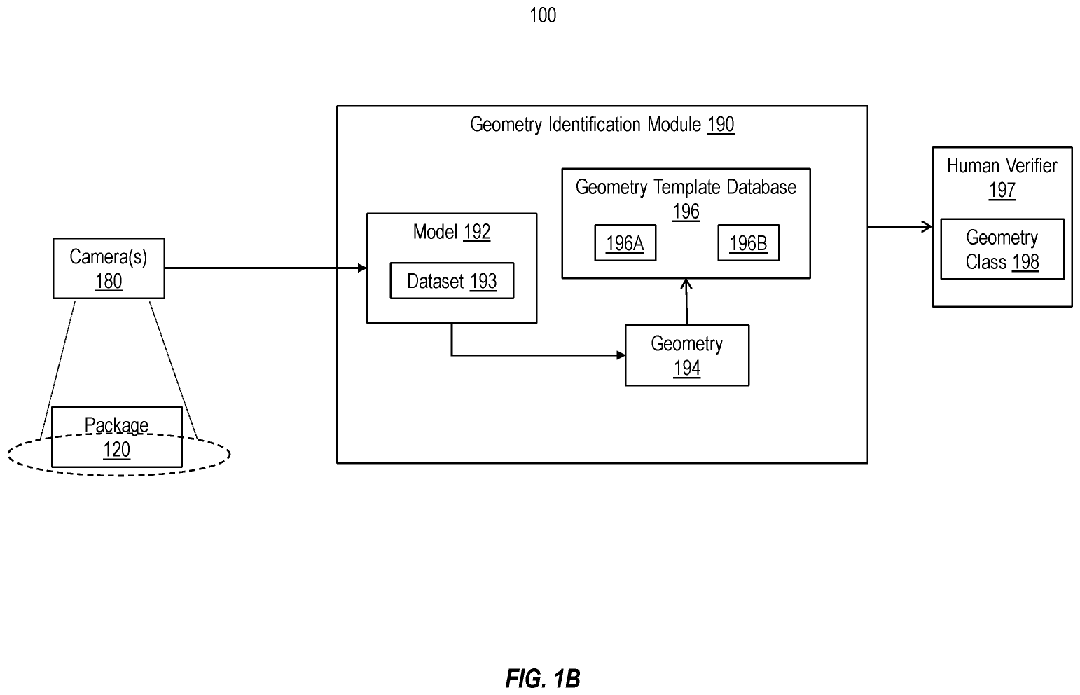

FIG. 1A discloses aspects of an environment in which embodiments of the invention may be deployed or implemented. FIG. 1A illustrates a system (e.g., a logistics system) that includes edge nodes, represented by an edge node 150, which may be a mobile vehicle (e.g., forklifts, Autonomous Mobile Robots (AMR), automatic pallet loaders), and a central node 105. The edge nodes and the central node may coordinate to perform logistics operations.

The environment 100 may be a warehouse or other environment. In the environment, the edge node 150 is configured to load packages 120, 130, and potentially any number of additional packages as illustrated by the ellipses 140 onto a pallet 110. The edge node 150 includes an RFID reader 155 that is configured to read an RFID tag or the like 115 that is coupled to the pallet 110. The RFID tag 115 is configured to identify the pallet 110 and may be used to track the pallet 110 across the environment 100.

Each of the packages 120, 130, and 140 loaded onto the pallet 110 include a package identification (ID). For example, the package 120 includes a package ID 125 and the package 130 includes a package ID 135. Although not illustrated, the additional packages 140 may also include a package ID. The packages IDs 125 and 135 (and those of the additional packages 140) may be a barcode, an RFID tag, or any other suitable means that allows the packages to be tracked across the environment 100 and to be associated with the pallet 110.

As shown in FIG. 1A, each of the packages 120, 130, and 140 are associated with a fragility level that is an indication of how fragile the package and/or the contents of the package are. For example, the package 120 is associated with a fragility level 126, the package 130 is associated with a fragility level 136, and the additional packages 140 may be associated with an unillustrated fragility level. A higher fragility level typically indicates that a package is relatively more fragile, and a lower fragility level typically indicates that a package is relatively less fragile. In some embodiments, the fragility level of each of the packages may be assigned to the packages at a shipping origin of the packages. In other embodiments, the fragility levels may be determined based on how often they are damaged in the environment 100 as will be explained in more detail to follow. The fragility levels may also be used to help adapt the driving patterns of the edge node 150 as will also be explained in more detail to follow.

The packages 120, 130, and 140 are flagged with geometry information that specifies information about the geometric shape of the package. For example, the package 120 may be flagged with geometry information 127, the package 130 may be flagged with geometry information 137, and the additional packages 140 may be flagged with unillustrated geometry information. The geometry information may be a model of the package volume, or it may be a known geometry class. In some embodiments, the geometry information may be assigned at the shipping origin of the packages.

In some embodiments, however, no geometry information is provided by the shipping origin and thus needs to be determined at the environment 100. FIG. 1B illustrates an embodiment of determining the geometry information at the environment 100 by using a geometry identification module 190. In some embodiments, the geometry identification module 190 may be included at the edge node 150 in cases where the edge node 150 includes sufficient processing power. In other embodiments, the geometry identification module 190 is included at the central node 105 given that typically the central node 105 has greater processing power relative to the edge node 150.

As illustrated, one or more cameras 180 are located in the environment 100 at the location where the pallet 110 is being loaded. In some embodiments the cameras 180 may be included in the edge node 150, in other embodiments the cameras 180 may be mounted on walls or the like in the location where the pallet 110 is being loaded, and in still other locations the some of the cameras 180 may be included in the edge node 150 and some of the cameras 180 may be mounted on the walls.

In operation, the one or more cameras 180 scan a package such as the package 120 and generate a dataset 193 of geometries related to images or video streams captured by the cameras 180. The dataset 193 is provided to a machine-learning model 192 of the geometry identification module 190, which in some embodiments may be a computer vison model. The machine-learning model 192 is configured to extract a geometry 194 of the package 120 using the dataset 193.

The geometry 194 is compared with known geometry templates such as geometry templates 196A and 1966 that are stored in a geometry template database 196 of the geometry identification module 190. If the geometry 194 matches one of the geometry templates stored in the geometry template database 196, then the geometry 194 is assigned a geometry class, such as geometry class 198, that corresponds to the geometry class of the matching template.

In some embodiments, the geometry class 198 is provided to a human verifier 197, who verifies that the geometry 194 has been assigned the correct geometry class. In other embodiments, when the geometry 194 does not match one of the geometry templates stored in the geometry template database 196, the human verifier 197 may label the geometry with a new geometry class and may then update the one of the geometry templates stored in the geometry template database 196 to reflect the new geometry class. In still other embodiments, where the geometry identification module is not present, the human verifier 197 (or some other human operator) may simply flag each package with geometry information 127 at the time the packages are loaded onto the pallet 110.

The packages 120, 130, and 140 are also flagged with package format information that specifies information about the format of the package and/or its contents. For example, the package 120 may be flagged with package format information 128, the package 130 may be flagged with package format information 138, and the additional packages 140 may be flagged with unillustrated package format information.

As illustrated, the central node 105 includes a package tracking database 160 that is configured to track one or more pallets across the environment 100 by storing information about the one or more pallets and the package loaded onto the pallets. For example, the package tracking database 160 stores information specifying that the packages 120, 130, and the additional packages 140 have been loaded onto the pallet 110. This information may be provided to the package tracking database 160 by the edge node 150 after it reads the RFID tag 115 of the pallet 110 and then reads the package IDs, such as the package IDs 125 and 135, as the packages are loaded onto the pallet 110. In addition, as illustrated by the 150 being associated with the pallet 110 in FIG. 1A, the package tracking database 160 also stores that the node 150 is loading, transporting and/or otherwise handling the pallet 110. In this way, a record of which node is handling the pallet 110 is kept in the package tracking database 160.

In some embodiments, the fragility levels (e.g., fragility levels 126 and 136), the geometry information (e.g., geometry information 127 and 137), and the package format information (e.g., package format information 128 and 138) for each of the packages loaded onto the pallet 110 are also stored in the package tracking database 160. The fragility levels and the package format information for each package may be loaded into the package tracking database 160 when they are received from the shipping origin, they may be obtained by a human operator or the edge node 150 and then provided to the package tracking database 160. The geometry information may be loaded into the package tracking database 160 when it is received from the shipping origin, or it may be loaded when it is determined in the manner previously described.

The central node 105 also includes a fragility module 170, which may comprise one or more machine-learning models in some embodiments. In operation, the fragility module 170 uses the fragility level of each of the packages loaded onto a pallet to determine an aggregate fragility level 175 for the loaded pallet. The aggregate fragility level 175 may be determined in any reasonable way. For example, in one embodiment the aggregate fragility level 175 may be selected as the maximum fragility among all the loaded packages. In some embodiments, the aggregate fragility level 175 may also include the geometry information of the packages (e.g., geometry information 127 and 137). In such embodiments, the class (e.g., each known geometry template 196A or 196B) related to the geometry information may be used in the computation of the aggregate fragility level 175.

For example, in the embodiment of FIG. 1A, the fragility module 170 may use the fragility level 126 for the package 120, the fragility level 136 for the package 130, and the fragility levels of the additional packages 140 to determine the aggregate fragility level 175 for the pallet 110. In some embodiments, the geometry information 127 for the package 120, the geometry information 137 for the package 130, and the geometry information of the additional packages 140 may also be used in the determination of the aggregate fragility level 175 for the pallet 110.

The package tracking database 160 may also store information about additional pallets and the packages that have been loaded onto them by other edge nodes. For example, the package tracking database 160 may store information about a pallet 165, a pallet 166, and any number of additional pallets as illustrated by the ellipses 167.

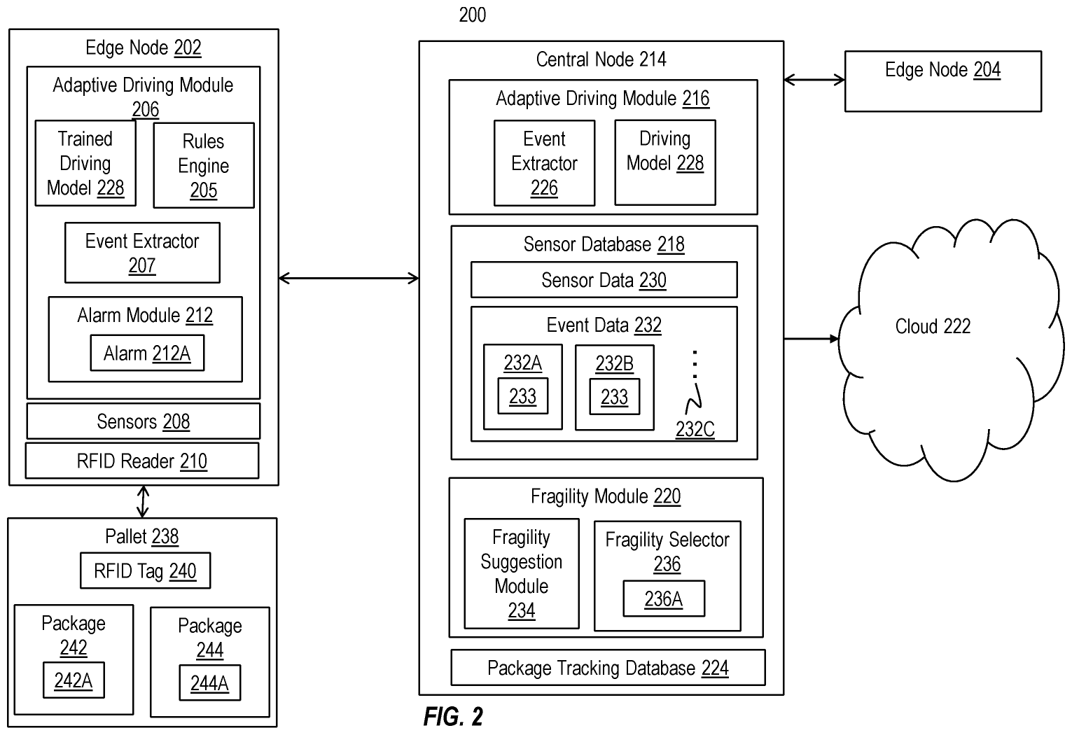

FIG. 2 discloses aspects of an environment 200 in which embodiments of the invention may be deployed or implemented. FIG. 2 illustrates a system (e.g., a logistics system) that includes edge nodes, represented by edge nodes 202 and 204 (e.g., forklifts), which may correspond to the edge node 150, and a central node 214, which may correspond to the central node 105. The edge nodes and the central node may coordinate to perform logistics operations.

The environment 200 may be a warehouse or other environment. The edge nodes 202 and 204 operate or exist in the environment 200. In the context of a warehouse environment, the edge nodes 202 and 204 may have different types and correspond to or are associated with objects related to the warehouse environment. In the present example the edge nodes 202 and 204 may correspond to or are associated with forklifts, AMRs, or other mobile device, vehicles, machines, etc. The edge nodes 202 and 204 may operate in the environment 200, which may also be associated with other objects (e.g., machinery, hazards, persons, corridors, corners, shelving) that may be mobile, movable, or stationary and which are hazards from the perspective of the edge nodes 202 and 204. In particular, the other objects may be hazards when the edge nodes 202 and 204 are moving a pallet such as the pallet 110 that is loaded with packages, especially packages that have a high fragility level.

Each of the edge nodes 202 and 204 may be associated with or include sensors. The sensors may depend on the associated object. Example sensors include position sensors (at least one), and inertial sensors (at least one). The edge nodes 202 and 204 may include compute resources such as a processor, memory, networking hardware, or the like.

The central node 214 (e.g., implemented in a near edge infrastructure or in a cloud 222) is configured to communicate with each of the edge nodes 202 and 204. The communication may be performed using radio devices through hardware such as a router or gateway or other devices. Depending on the sensors and the configuration of the node, the communication may be one way. The edge nodes 202 and 204 may also receive information from the central node 214 and use the information to perform various operations including logistics operations.

For example, the edge node 202, which may be attached to or be an integral part of an object such as forklift, may be configured with sensors 208 of various types and with sufficient hardware (e.g., processor, memory) to implement and run a local adaptive driving module 206 using the data collected or generated by the sensors 208 of the edge node 202 and by the fragility levels of packages loaded on a pallet being moved by the edge node 202.

If the edge node 202 corresponds to or is associated with a forklift, the sensors of the edge node 202 may be arranged on the forklift in different manners. For example, position sensors may be deployed on the metal structures that move the forklift's arms (forks or tines). By placing sensors on the arms, the positions of the arms relative to the forklift body and in the environment 200 can be determined. Alternatively, the edge node 202 may be associated with a position sensor. In one example, the sensors 208 of the edge node 202 allow a center position of the node to be determined. The position sensors generate positional data that determine a position of the edge node 202 in the environment 200. Positional data can also be collected as time series data, which can be analyzed to determine a position of the forklift, a velocity of the forklift, a trajectory or direction or travel, that the forklift is turning or cornering, or the like. The sensors 208 may also include inertial sensors that allow acceleration and deceleration to be detected in multiple directions. The sensors 208 may further include weight sensors that measure a weight of the pallet and packages transported by the edge node 202.

The edge node 202 also includes a RFID reader 210 in addition to the sensors 208. The edge node 202 uses the RFID reader 210 to read the RFID tag 240 of a pallet 238, which may correspond to the pallet 110, that the edge node 202 is transporting. The edge node 202 may also use the RFID reader 210 to read a package ID 242A of a package 242 and a package ID 244A of a package 244 as well as various unillustrated packages that are loaded onto the pallet 238. The edge node 202 can use the pallet RFID tag 240 and the package IDs 242A and 244A to log into a package tracking database 224, which may correspond to the package tracking database 160, that the edge node 202 is currently transporting the pallet 238 and its loaded packages. The package information such as the fragility level, geometry information, and/or package format information previously discussed that is logged in the package tracking database 224 for each package can then be associated with the edge node 202 in the package tracking database 224. In particular, the fragility level of the packages can be associated with the edge node 202 so that any sensor data collected by the sensors 208 is associated with a particular fragility level.

The central node 214 may include a sensor database 218. The sensor database 218 may be configured to store sensor data 230 received from the edge node 202 (and 204 and/or other nodes in the environment 200). Because the edge node 202 is associated with or integrated with objects, the sensor database 218 stores information about the objects in the environment 200. More specifically, the sensor database 218 may be used to store the information generated by or at the edge node 202 (and 204 and/or other nodes in the environment 200). The sensor database 218 may include a database for different sensor types. Thus, the sensor database 218 may include a position data database, an inertial database, and the like. In another example, the sensor database 218 may store all sensor data together and/or in a correlated form such that position data can be correlated to inertial data at least with respect to individual nodes and or in time.

The sensor data 230 will include features related to the type of sensor data that was collected when the edge node 202 is transporting the pallet 238. For example, inertial data will include features related to the acceleration and deceleration of the edge node, position data will include features related to the position of the edge node 202, weight data will include features related to weight of the pallet 238, and contextual data will include features related to contextual data such as the height of the edge node 202 or its angle of operation. There may be any number of additional features related to various other types of sensor data collected by the sensors 208.

The central node 214 may also include a near edge adaptive driving module 216, that is configured to train a model 228 for directing the driving patterns of the edge node 202 as will be explained in more detail to follow. The adaptive driving module 216 includes an event extractor 226. In operation, the event extractor 226 is configured to extract event data 232 related to driving events from the sensor data 230 stored in the sensor database 218. The event data 232 includes events inferred from the sensor data 230 when a driving pattern of the edge node 202 was non-normative or anomalous. In other words, when the driving pattern differed from the driving pattern seen in most of the sensor data 230, the driving pattern may be considered indicative of anomalous driving patterns. The anomalous driving pattern may be indicative of an unwanted incident such as a collision or dropping a pallet and/or package being transported. For example, an extracted event 232A may be when the edge node 202 quickly decelerated due to a collision with another object in the environment 200 such as another node. An extracted event 232B may be when the edge node 202 accelerates quickly to avoid a collision with another object in the environment 200 such as another node. The ellipses 232C illustrate that there may be any number of additional events included in the event data 232. In some embodiments, in addition to or alternatively, the event data 232 may be provided by the adaptive driving module 206 of the edge node 202.

The events 232A and 232B may also be associated with historical package information 233. The package information 233 may include a fragility level (e.g., fragility level 126 and 136) and/or geometry information (e.g., geometry information 127 and 137) for each package that the edge node 202 was transporting when the events 232A and 232B occurred. In this way, the event data 232 is correlated with the package information 233 and this correlation can be used when training the model driving model 228 as will be explained. In those embodiments where the adaptive driving module 206 of the edge node 202 provides the event data 232, the package information 233 may be associated with the event data by the adaptive driving module 206.

The central node 214 may also include a fragility module 220, which may correspond to the fragility module 170, that is configured to determine an aggregate fragility level that can be used by the near edge adaptive driving module 216 to train the edge node adaptive driving module 206 as will be explained in more detail to follow. The fragility module 220 includes a fragility suggestion module 234 that is configured to suggest a fragility level that should be used during training. In operation, the fragility suggestion module 234 accesses the package tracking database 224 for historical geometry information (e.g., geometry information 127 and 137) about the packages (e.g., packages 120, 130, and 140) loaded onto a pallet (e.g., pallet 110) that is being transported by the edge node 202. The fragility suggestion module 234 also accesses the event data 232 and determines past driving events that occurred when the edge node 202 was transporting or moving a pallet with packages having similar geometry information as the historical geometry information in the package tracking database 224. In this way, the fragility suggestion module 234 is able to revise overtime the fragility levels (e.g., fragility level 126 and 136) for each package stored in the package tracking database 224 using the historical geometry information and event data. In other words, the fragility suggestion module 234 is able to revise the fragility level determined by the shipping origin that was logged into the package tracking database 224 to a more accurate level by analyzing the historical geometry information and event data.

The fragility module 220 also includes a fragility selector 236. In operation, the fragility selector 236 is configured to access the package tracking database 224 and analyze the various fragility levels (e.g., fragility levels 126 and 136) for all the packages (e.g., packages 120, 130, and 140) for a given pallet such as the pallet 110. The fragility levels may be those that were provided by the shipping origin, or they may be those that were revised by the fragility suggestion module 234. Based on the analysis of the various fragility levels, the fragility selector is configured to retrieve the lowest fragility level and to designate this as the aggregate fragility level 236A, which may correspond to the aggregate fragility level 175.

The fragility suggestion module 234 may then revise the fragility levels as described and the fragility selector may select the aggregate fragility level 236A for the pallet 238.

The aggregate fragility level 236A is sent to both the adaptive driving module 216 and the adaptive driving module 206 of the edge node 202 for use in training and using a driving model 228 or applying the aggregate fragility level 236A to a rule engine 205. Based on the driving model 228 or the rules engine 205, an alarm module 212 of the edge node 202 may generate an alarm when the detected driving pattern is determined to be below an acceptable threshold as will be explained in more detail to follow.

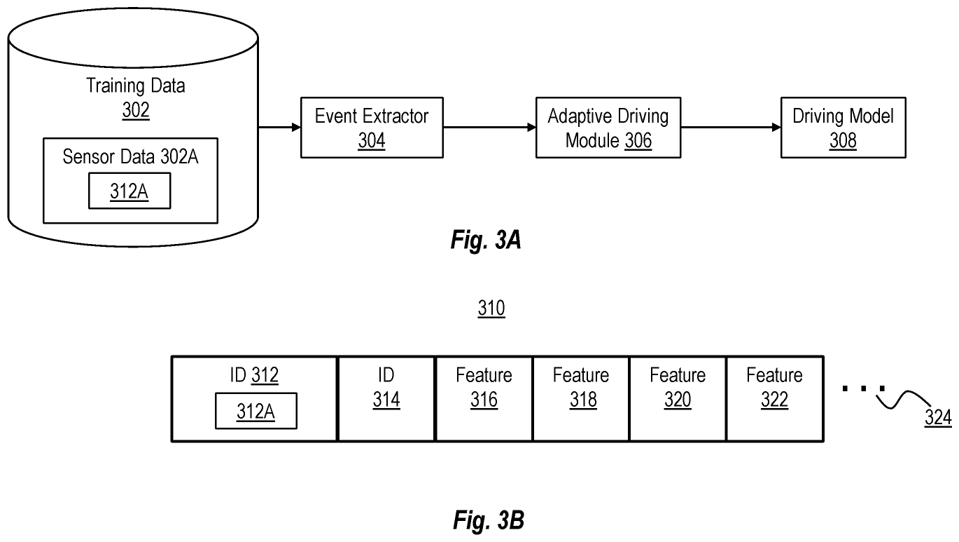

FIG. 3A illustrates aspects of training a machine-learning driving model such as the driving model 228 by the central node 214. As shown in FIG. 3A, a training data set 302 is used to train the machine-learning driving model. The training data set 302 includes sensor data 302A that may correspond to sensor data 230 collected from the sensors 208. As described in relation to the sensor data 230, the sensor data 302A is associated with an aggregate fragility level 312A that may correspond to the aggregate fragility level 236A. In other words, the sensor data 302A is associated with the aggregate fragility level 236A because at the time the sensors 208 collected the data the edge node 202 was transporting a pallet loaded with one or more packages having an aggregate fragility level determined in the manner previously described.

The training data 302A is processed by an event extractor 304, which may correspond to event extractor 226, that extracts event data from the sensor data 302A based on one or more features of the sensor data. As previously described, inertial data will include features related to the acceleration and deceleration of the edge node, position data will include features related to the position of the edge node 202, weight data will include features related to weight of the edge node 202, and video data will include features related to the overall environment of the edge node 202. For example, inertial data will include features related to the acceleration and deceleration of the edge node, position data will include features related to the position of the edge node 202, weight data will include features related to weight of the edge node 202, and video data will include features related to the overall environment of the edge node 202. There may be any number of additional features related to various other types of sensor data collected by the sensors 208.

FIG. 3B illustrates an embodiment of a data structure 310 that can be used as the training data 302A. As illustrated, the data structure 310 includes an ID 312, which may be a pallet ID based on the RFID tag of the pallet and/or a package ID that is associated with the aggregate fragility level 312A. An ID 314 of the sensor 208 that collected the sensor data 302A. The data structure 310 also includes a feature 316, a feature 318, a feature 320, and any number of additional features as illustrated by the ellipses 324. The features 316, 318, 320, 322, and 324 correspond to the features discussed above. It will be noted that the data structure 310 is only one of numerous data structures that may be implemented by the embodiments disclosed herein.

The adaptive driving module, which may correspond to the adaptive driving module 306, is then configured to analyze the plurality of features to train a machine-learning driving model 308, which may correspond to the machine-learning driving model 228. The machine-learning driving model 308 is trained to detect anomalous or non-normative instances of sensor data 302A. For example, for a given sensor data reading, the machine-learning driving model 308 is configured to determine a probability that the given sensor data instance is anomalous compared to the other sensor data instances contained in the training data set 302. The anomalous or non-normative instances correspond to the event data 232 for the anomalous or non-normative driving patterns.

In some embodiments, for each feature, a separate machine-learning driving model 308 is trained. As such, multiple machine-learning models may be trained to detect anomalous instances of the sensor data. Different machine-learning techniques may be implemented. In some embodiments, clustering-based anomaly detection techniques are used to train a model to detect a distance between the anomalous instances of the logon event data and normal instances of the logon event data. In some embodiments, are used a model is trained to detect whether new instances the logon event data is within one or more clusters. Many different machine-learning algorithms may be used to train the models, including (but not limited to) convolutional neural networks, multilayer neural networks, recursive neural networks, autoencoder neural networks, deep neural networks including autoencoder neural networks, logistic regression, isolation forest, k-nearest neighbors, support vector machines (SVM), density-based algorithm, elliptic envelope, local outlier factor, Z-score, Boxplot, statistical techniques, time series techniques, or any other reasonable machine-learning algorithms. Thus, the embodiments and claims disclosed herein are not limited to any particular type of machine-learning model.

Returning to FIG. 2, the driving model 228 is then deployed at the edge node 202. Specifically, in one embodiment the driving model 228 is deployed in the adaptive driving module 206. Since the driving model 228 is now trained based on the historical sensor data stored in the sensor database 230 and the historical aggregate package information 233 including the historical fragility level. Accordingly, the driving model is shown as trained driving model 228 at the adaptive driving module 206.

In operation, the adaptive driving module 206 uses the trained driving model 228 to determine current driving patterns for the edge node 202 (and any other edge node such as edge node 204) when the edge node 202 is transporting a pallet loaded with packages having the aggregate fragility level 236A as discussed previously. Specifically, the adaptive driving module 206 receives sensor data from the sensors 208 and uses the trained driving model 228 in conjunction with an event extractor 207 to determine when the driving patterns of the edge node 202 are anomalous or non-normative such that it can be inferred that such driving patterns are likely to cause damage to the packages 242 and 244 being transported.

In such circumstances, an alarm module 212 included in the edge node 202 may generate an alarm 212A that warns the driver of the edge node 202 (when the edge node 202 is a forklift) to change the driving patterns to one that is considered non-anomalous or normal. The generated alarm may be a light that is illuminated in a location where the driver of the edge node 202 can see the light, an audio warning alarm, a combination of the two, or some other type of reasonable warning. In response to the alarm 212A, the driver of the edge node 202 should take corrective action such as slowing down to change his or her driving patterns to avoid the potential damage to the packages 242 and 244.

Alternatively, for AMRs or the like, the alarm 212A may be provided to control module of the AMR. In response, the control module may take corrective action to change the driving patterns. If no such actions are taken, it may be inferred there is a malfunction in the AMR.

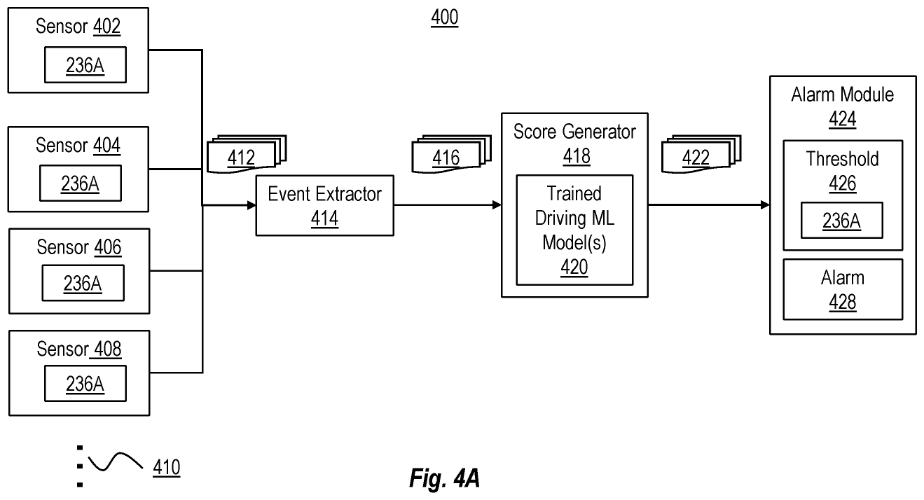

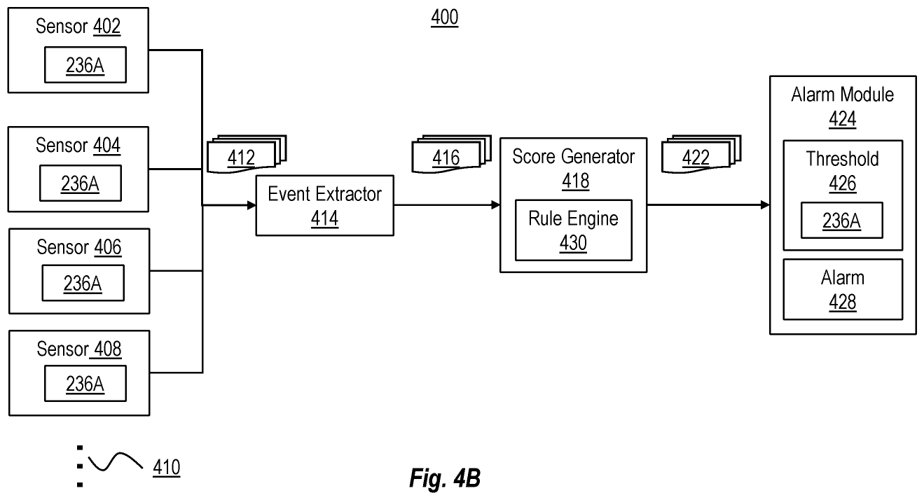

FIG. 4A illustrates an example architecture of an adaptive driving module 400, which may correspond to the adaptive driving module 206. As illustrated in FIG. 4A, the adaptive driving module 400 includes a feature extractor 414, which may correspond to the feature extractor 207. The feature extractor 414 is configured to obtain sensor datasets 412, which may correspond to instances of sensor data received from sensors 402, 404, 406, 408, and any number of additional sensors as illustrated by the ellipses 410, which may correspond to the sensors 208. As previously described, the sensor data is associated with the aggregate fragility level 236A because the sensor data is collected as the edge node 202 is transporting the pallet 238 loaded with the packages 242 and 244. The sensor datasets 412 may have the same may have a data structure such as the data structure 310.

In response to receiving the sensor datasets 412, the event extractor 414 is configured to extract a set of features 416 from the sensor datasets 412. The set of features 416 correspond to the features discussed previously.

The extracted set of features 416 are then fed into a score generator 418. The score generator 418 embodies one or more trained driving machine-learning models 420, which may correspond to the trained driving model 228. The one or more trained driving machine-learning models 420 are configured to generate a probability score 422, indicating a probability that a given instance of the sensor data is anomalous. In some embodiments, where the trained driving machine-learning model 420 is an autoencoder deep neural network, the probability score 422 may be based on a reconstruction error, where the reconstruction error for normal instances of sensor data is low and the reconstruction error for anomalous instances of sensor data is high. In other embodiments, the probability score 422 may be based on a distance between normal instances of sensor data and anomalous instances of the sensor data. Those instances that close together are given a probability score indicating that they are normal and those that are far apart are given a probability score indicating that they are anomalous. In still other embodiments, the probability score 422 may be determined in any reasonable way based on the machine-learning model being implemented.

The probability score 422 is then processed by an alarm module 424, which may correspond to the alarm module 212. In some embodiments, when the probability score 422 for a given sensor data instance is less than a predetermined threshold 426, the alarm module 424 determines that instance as being “normal”. Conversely, when the probability score 422 for a given sensor data instance is greater than the predetermined threshold 426, the alarm module 424 determines that instance as being “anomalous” or “non-normative”. When the sensor data instance is labeled as “anomalous” or “non-normative”, the alarm module may generate an alarm 428 that may correspond to the alarm 212A. Corrective action may then be taken in the manner previously described.

The predetermined threshold 426 may be based on the aggregate fragility level 236A of the pallet 238 and its packages 242 and 244. Accordingly, when the aggregate fragility level 236A is relatively high, thus indicating that the packages loaded onto the pallet 238 are relatively fragile, the predetermined threshold 426 will be set to a lower value. This means that more probability scores 422 will be above the threshold, which in turn will generate more alarms 428, leading to a more constrained operation of edge nodes 202 transporting fragile loads. Conversely, when the aggregate fragility level 236A is relatively low, thus indicating that the packages loaded onto the pallet 238 are relatively non-fragile, the predetermined threshold 426 will be set to a higher value. This means that more probability scores 422 will be below the threshold, which in turn will generate less alarms 428, leading to less constrained operation of edge nodes 202 transporting non-fragile loads. In embodiments where the trained driving machine-learning model 420 is an autoencoder deep neural network, the predetermined threshold 426 may help determine a maximum reconstruction error.

In some embodiments, the adaptive driving module 206 may not have access to the trained driving model 228. This may be because the model has not yet been trained by the central node due to there not being enough historical sensor data and fragility data accumulated at the central node 214. Accordingly, in some embodiments the edge node 202 may also include a rules engine 205. In operation, the rules engine 205 includes one or more rules that specify how the edge node 202 should operate in response to detected event data and the current aggregate fragility level 236A. For example, a first rule may indicate that if a certain event is detected, the edge node 202 should decrease its speed as the event shows a higher speed is likely to lead to a dangerous outcome. There can be any number of rules included in the rule engine 205, which will typically be based on experimentation and experience. Once the trained driving model 228 is available, the use of the rules engine 205 may be discontinued. FIG. 4B shows an embodiment where the rule engine 430 is used instead of the machine-learning model 420.

The embodiments disclosed herein may be continuously updated as needed. For example, the trained driving model 228 may be updated as needed every time a pallet is loaded with different packages, thus causing an update to the aggregate fragility level 236A or any time the edge node 202 transports a new pallet. In this way, the aggregate fragility level of a pallet and/or its loaded packages is always included in the alarms and other driving instructions provided by the adaptive driving module 206. In addition, the use of the package tracking databases allows packages and their fragility levels to be tracked across the environment. In this way, any time any movable edge node transports the package, the fragility of a package can always be made available to the operator of the movable edge node so that driving patterns can be adjusted as needed to correspond to the fragility of a package.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, logistic operations.

New and/or modified data collected and/or generated in connection with some embodiments, may be stored in an environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM).

Particularly, devices in the operating environment may take the form of software, physical machines, containers, or VMs, or any combination of these, though no particular device implementation or configuration is required for any embodiment.

As used herein, the term ‘data’ is intended to be broad in scope. Thus, that term embraces, by way of example and not limitation, video data, sensor data, data segments such as may be produced by data stream segmentation processes, data chunks, data blocks, atomic data, or the like.

Example embodiments of the invention are applicable to any system capable of storing and handling various types of objects, in analog, digital, or other form. Although terms such as file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited. Each of the Figures may disclose aspects of structure and methods.

Following are some further example embodiments of the invention. These are presented only by way of example and are not intended to limit the scope of the invention in any way.
Embodiment 1. A method, comprising: receiving one or more datasets based on one or more instances of sensor data received from one or more sensors, the sensor data being associated with an aggregate fragility level that is indicative of the fragility of one or more packages being transported by a movable edge node in an edge environment; extracting a plurality of features based on the one or more datasets; based on the extracted features, determining one or more events that are indicative of anomalous driving patterns for the movable edge node; and in response to determining the one or more events, generating an alarm based on a predetermined threshold that is based on the aggregate fragility level.
Embodiment 2. The method of embodiment 1, wherein determining one or more events that are indicative of anomalous driving patterns for the movable edge node comprises: generating a probability score based on the plurality of features, using one or more machine-learning models that have been trained using a subset of the one or more datasets, the probability score indicating whether an instance of the sensor data is anomalous; and comparing the probability score to the predetermined threshold.
Embodiment 3. The method of embodiment 1 and/or 2, wherein when the aggregate fragility level is a first value, the predetermined threshold is set to a second value and when the aggregate fragility level is set to a third value that is higher than the first value, the predetermined threshold is set to a fourth value that is lower than the second value.
Embodiment 4. The method of embodiment 1, 2, and/or 3, wherein the aggregate fragility level is set by a shipping origin and is placed in a database.
Embodiment 5. The method of embodiment 1, 2, 3, and/or 4, wherein the one or more packages are loaded onto a pallet and the aggregate fragility level is determined based on individual fragility levels of each of the one or more packages
Embodiment 6. The method of embodiment 5, wherein the aggregate fragility level is based on a geometry of the one or more packages loaded onto the pallet.
Embodiment 7. The method of embodiment 6, wherein the geometry of the one or more packages is determined by a machine-learning model when the one or more packages are loaded onto the pallet.
Embodiment 8. The method of embodiment 1, 2, 3, 4, 5, 6, and/or 7, wherein the alarm is configured to notify the movable edge node that corrective action should be taken in response to the anomalous driving patterns.
Embodiment 9. The method of embodiment 1, 2, 3, 4, 5, 6, 7, and/or 8, wherein the aggregate fragility level is refined based on historical events indicative of anomalous driving patterns and a geometry of the one or more packages.
Embodiment 10. The method of embodiment 1, 2, 3, 4, 5, 6, 7, 8, and/or 9, wherein the instances of sensor data are one or more of inertial sensor data, position sensor data, or weight sensor data.
Embodiment 11. A method for performing any of the operations, methods, or processes, or any portion of any of these, or any combination thereof disclosed herein.
Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

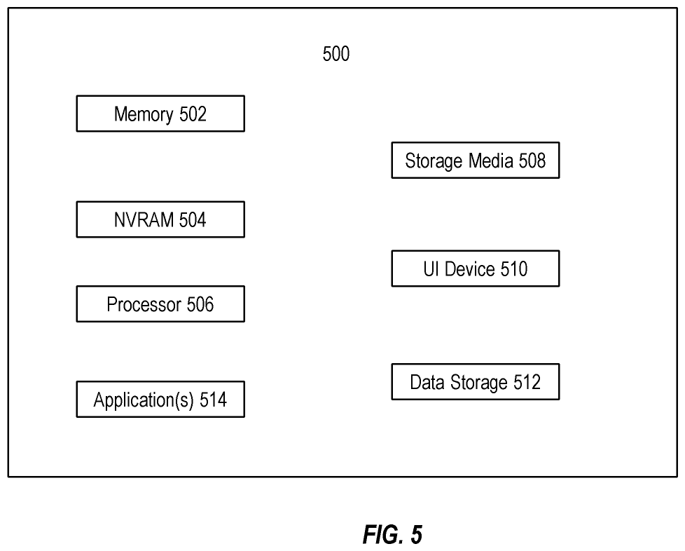

With reference briefly now to FIG. 5, any one or more of the entities disclosed, or implied, by Figures and/or elsewhere herein, may take the form of, or include, or be implemented on, or hosted by, a physical computing device, one example of which is denoted at 500. As well, where any of the aforementioned elements comprise or consist of a container or a virtual machine (VM), that VM may constitute a virtualization of any combination of the physical components disclosed in FIG. 5.

In the example of FIG. 5, the physical computing device 500 includes a memory 502 which may include one, some, or all, of random-access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid-state device (SSD) storage. As well, one or more applications 514 may be provided that comprise instructions executable by one or more hardware processors 506 to perform any of the operations, or portions thereof, disclosed herein. The device 500 may alternatively represent a computing system, a cloud or edge environment, a node, or the like or combination thereof.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving one or more datasets based on one or more instances of sensor data received from one or more sensors, the sensor data being associated with an aggregate fragility level that is indicative of the fragility of one or more packages being transported by a movable edge node in an edge environment;
extracting a plurality of features based on the one or more datasets;
based on the extracted features, determining one or more events that are indicative of anomalous driving patterns for the movable edge node; and
in response to determining the one or more events, generating an alarm based on a predetermined threshold that is based on the aggregate fragility level.

2. The method of claim 1, wherein determining one or more events that are indicative of anomalous driving patterns for the movable edge node comprises:
generating a probability score based on the plurality of features, using one or more machine-learning models that have been trained using a subset of the one or more datasets, the probability score indicating whether an instance of the sensor data is anomalous; and
comparing the probability score to the predetermined threshold.

3. The method of claim 1, wherein when the aggregate fragility level is a first value, the predetermined threshold is set to a second value and when the aggregate fragility level is set to a third value that is higher than the first value, the predetermined threshold is set to a fourth value that is lower than the second value.

4. The method of claim 1, wherein the aggregate fragility level is set by a shipping origin and is placed in a database.

5. The method of claim 1, wherein the one or more packages are loaded onto a pallet and the aggregate fragility level is determined based on individual fragility levels of each of the one or more packages.

6. The method of claim 5, wherein the aggregate fragility level is based on a geometry of the one or more packages loaded onto the pallet.

7. The method of claim 6, wherein the geometry of the one or more packages is determined by a machine-learning model when the one or more packages are loaded onto the pallet.

8. The method of claim 1, wherein the alarm is configured to notify the movable edge node that corrective action should be taken in response to the anomalous driving patterns.

9. The method of claim 1, wherein the aggregate fragility level is refined based on historical events indicative of anomalous driving patterns and a geometry of the one or more packages.

10. The method of claim 1, wherein the instances of sensor data are one or more of inertial sensor data, position sensor data, or weight sensor data.

11. A non-transitory storage medium having stored therein instructions that are executable by one or more hardware processors to perform operations comprising:
receiving one or more datasets based on one or more instances of sensor data received from one or more sensors, the sensor data being associated with an aggregate fragility level that is indicative of the fragility of one or more packages being transported by a movable edge node in an edge environment;
extracting a plurality of features based on the one or more datasets;
based on the extracted features, determining one or more events that are indicative of anomalous driving patterns for the movable edge node; and
in response to determining the one or more events, generating an alarm based on a predetermined threshold that is based on the aggregate fragility level.

12. The non-transitory storage medium of claim 11, wherein determining one or more events that are indicative of anomalous driving patterns for the movable edge node comprises:
generating a probability score based on the plurality of features, using one or more machine-learning models that have been trained using a subset of the one or more datasets, the probability score indicating whether an instance of the sensor data is anomalous; and
comparing the probability score to the predetermined threshold.

13. The non-transitory storage medium of claim 11, wherein when the aggregate fragility level is a first value, the predetermined threshold is set to a second value and when the aggregate fragility level is set to a third value that is higher than the first value, the predetermined threshold is set to a fourth value that is lower than the second value.

14. The non-transitory storage medium of claim 11, wherein the aggregate fragility level is set by a shipping origin and is placed in a database.

15. The non-transitory storage medium of claim 11, wherein the one or more packages are loaded onto a pallet and the aggregate fragility level is determined based on individual fragility levels of each of the one or more packages.

16. The non-transitory storage medium of claim 15, wherein the aggregate fragility level is based on a geometry of the one or more packages loaded onto the pallet.

17. The non-transitory storage medium of claim 16, wherein the geometry of the one or more packages is determined by a machine-learning model when the one or more packages are loaded onto the pallet.

18. The non-transitory storage medium of claim 11, wherein the alarm is configured to notify the movable edge node that corrective action should be taken in response to the anomalous driving patterns.

19. The non-transitory storage medium of claim 11, wherein the aggregate fragility level is refined based on historical events indicative of anomalous driving patterns and a geometry of the one or more packages.

20. The non-transitory storage medium of claim 11, wherein the instances of sensor data are one or more of inertial sensor data, position sensor data, or weight sensor data.
